(19) United States
(12) Patent Application Publication
(10) Pub. No.: US 2003/0179146 A1
(43) Pub. Date: Sep. 25, 2003

(54) Method of fabricating waveguide channels

(76) Inventor: Stig Anders Peterson, Lovanger (SE)

Correspondence Address: Blakely Sokoloff Taylor & Zafman, Seventh Floor, 12400 Wilshire Boulevard, Los Angeles, CA, 90025-1026, US

(21) Appl. No.: 10/275,445

(22) PCT Filed: May 7, 2001
(86) PCT No.: PCT/SE01/00991

(30) Foreign Application Priority Data
May 5, 2000 (SE) 0001674-1

(51) Int. Cl. H01Q 13/00; H01P 3/123

(52) U.S. Cl. 343/776; 333/248; 29/600

(57) ABSTRACT

When manufacturing waveguides, for example densely located waveguide channels, for electromagnetic waves such as microwaves, the channels are produced from rod-shaped bodies (1) of a material permeable to the waves and non significantly attenuating the waves. The bodies (1) can for example project from a base plate (3) and their side surfaces are coated with electrically conducting material but not their free end surfaces (5). The interior of the bodies form the waveguiding channels, which have their walls formed from the layer of electrically conducting material. By giving the rod-shaped bodies suitable shapes for example an antenna side or half of a waveguide antenna can be manufactured. The rod shaped bodies can before applying the electrically conducting material be coated with one or several layers of non-attenuating and non-conducting lacquer filling pores and smoothing the surface of the bodies. Thereby, the layer of electrically conducting material obtains a smooth transition surface to the material of the bodies giving the channels good waveguiding characteristics. If the material used in the bodies has a strong surface porosity, the channels formed from the rod-shaped bodies become strongly attenuating to the electromagnetic waves. A set of such bodies located at the sides of each other and having suitable dimensions of the bodies gives an element working strongly attenuating to the electromagnetic waves.

### TECHNICAL FIELD

The present application relates to a method of manufacturing waveguide channels for microwaves, in particular waveguide channels arranged closely at or at the sides of each other, and furthermore a method of manufacturing elements for attenuating microwaves.

### BACKGROUND

In waveguide antennas for receiving and transmitting electromagnetic radiation having frequencies in for example the GHz range the largest possible portion of the surface of the antennas should consist of open channels that are densely packed, i.e. are located closely at or at the sides of each other. This results in that the walls between the channels become long and narrow. Manufacturing such long channels is impossible using the technology which at present is available for mass production. Waveguide antennas having such channels are for example disclosed in the published International patent application WO 94/11920.

Waveguide channels for microwaves are generally often made as metal tubes having accurate internal dimensions. Due to the required high accuracy the manufacture is costly and such charnels therefore have high prices.

### SUMMARY OF THE INVENTION

It is an object of the invention to provide a low-cost method of manufacturing waveguiding channels for electromagnetic waves such as microwaves.

It is another object of the invention to provide a simple method of manufacturing panels attenuating electromagnetic waves such as microwaves.

Thus, a body can be made from a material permeable for electromagnetic waves and thereafter be coated with electrically conducting material such as being metallized on some of its surfaces. For a suitable shape of the body and suitably selected metallized surfaces thereof then the interior of the body forms a waveguiding channel having wall surfaces constituted by the interior surfaces of the electrically conducting metal layer. The body can be given a suitable geometric shape so that different waveguiding devices can be obtained such as simple separate channels, waveguide lenses and filters.

If the material of the body has a surface porosity, suitably the surfaces of the body are first coated with a surface smoothing or evening material that does not significantly affect the propagation of the electromagnetic waves. This material can either be permanent or made to evaporate after coating with the electrically conducting material.

The surface porosity can also be employed for manufacturing a structure attenuating electromagnetic waves, in particular microwaves. The a plate shaped body can be produced having cut-outs or recesses made in a first large surface of the body. Thereafter the first large surface is coated with electrically conducting material for forming an electrically conducting surface layer having a rough lower surface at the continuation to the permeable or non-attenuating material having a surface porosity. The interior surface of the conducting material obtains such a roughness that it works strongly attenuating to waves incoming to the second, opposite large surface of the body. The cut-outs or recesses are suitably given such shapes that between them projecting rods are formed, the dimensions of the cross-sections of which somewhere are larger than half the wavelength of the electromagnetic waves in the material having a surface porosity. In addition to the attenuating effect resulting from the rough lower surface the waves are also hindered because of the dimensions of the cross-sections of the channels formed in the rods.

### BRIEF DESCRIPTION OF THE DRAWINGS

The invention will now be described by way of non limiting embodiments with reference to the accompanying drawings in which:

FIG. 1 is a perspective view of a portion of a half of a waveguide antenna,

FIG. 2a is a cross-sectional view of a portion of a waveguide antenna,

FIG. 2b is a cross-sectional view corresponding to FIG. 2a in a larger scale,

FIG. 3 is a perspective view of a waveguide antenna in which half of an antenna side is removed,

FIG. 4 is a perspective view of waveguides placed at the side of each other having special cross-sections, and

FIG. 5 is a view of an attenuating panel.

### DETAILED DESCRIPTION

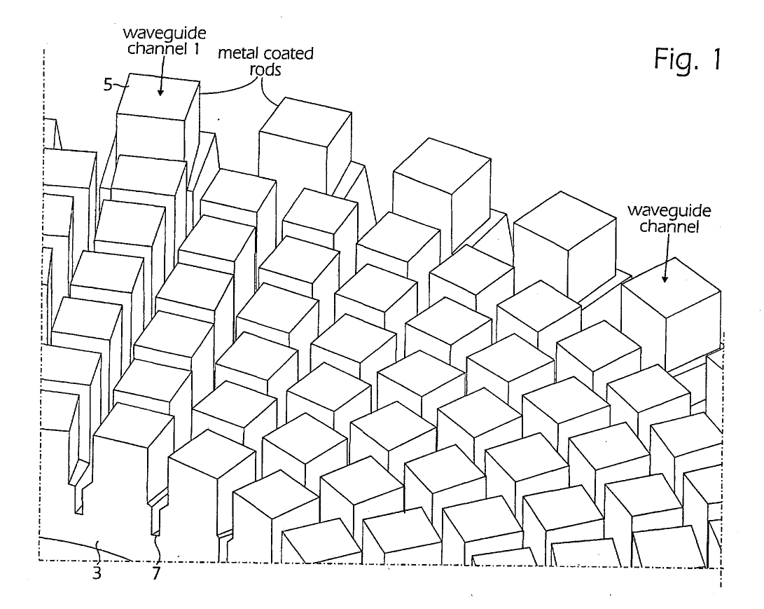

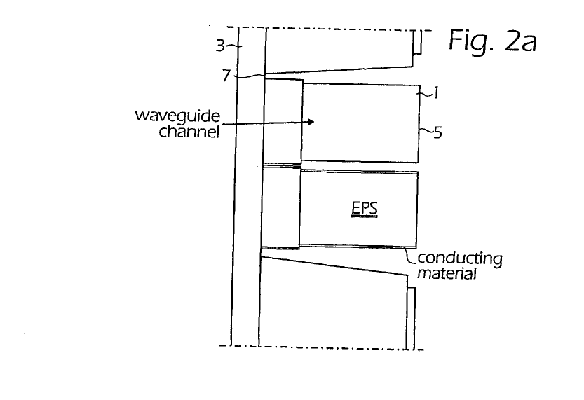

Materials exist which have such a low attenuation of electromagnetic waves that they can approximately be considered as air in spite of the fact that they in other respects have characteristics of solids. An example of such a material is EPS (Expanded PolyStyrene) that has an attenuation coefficient smaller than 0.1 dB/dm. This material can be easily used for manufacturing bodies having very varying shapes. In FIG. 1 is in a perspective view shown a portion of a waveguide antenna made from such a material having an insignificant attenuation for electromagnetic radiation, see also the part cross-sectional view of FIG. 2a. The waveguide antenna is formed from rods I that project to one side from a for example flat base plate 3 keeping the antenna together to form one unit. The rods 1 are on their side surfaces coated with an electrically conducting layer, see the description hereinafter. The end surfaces 5 of the rods have no such coating but in contrast there is a conducting coating on the free surface portions 7 of the base plate which are located between the rods 1. Thereby the interior of the rods, i.e. the regions inside them, interior of the electrically conducting surface layers, waveguiding channels. The rods 1 have furthermore geometric shapes adapted to the refracting function of the waveguide antenna so that the waveguiding channels together give the desired lens function. The rods can thus be tapering in a direction away from the base plate 3, as seen in the figures.

When using the above mentioned material EPS and similar expanded polymer materials such as expanded polyurethane for manufacturing waveguiding channels according to the description above, bodies of the material can be first produced by expansion caused by a suitable heating of an adapted amount of non-expanded material placed in a close mould cavity. Then the produced bodies can be coated with an electrically conducting paint for producing the conducting surface layer. The material of bodies produced in that way is however at the same time often porous, and if bodies made therefrom are directly coated with a conducting paint, pores 9 at the surface of the bodies are filled with the conducting paint. These pores can extend a good distance into the expanded polymer bodies, see FIG. 2b. A surface having such pores filled with an electrically conducting material is rough and attenuates electromagnetic wave propagating inside the bodies. The result is - particularly in the case where the bodies of the material contains pores extending deeply from the surface that the interior of the bodies do not obtain any waveguiding properties for electromagnetic waves and thus do not work as waveguides due to the fact that the interior of the bodies have metal walls which are strongly attenuating for electromagnetic waves inside the bodies.

To avoid such attenuating effects the bodies of the structural material used, for example EPS, are first coated with one or several layers of an electrically non-conducting lacquer that does not work significantly attenuating for electromagnetic waves and that both fills the surfaces pores and smooths the surface of the bodies. Thereafter the electrically conducting lacquer is applied and it then forms a completely smooth outer-most layer on the bodies having in particular a smooth interior surface where this lacquer continues into the next underlying layer of non attenuating lacquer. The layer of electrically non-conducting lacquer can be applied to the bodies by dipping or immersing or by inmould-methods.

Alternatively the bodies can be first coated with an electrically non conducting liquid that also both fills surface pores of the bodies and smooths the surface of the bodies. The liquid can be selected so that it prevents the electrically conducting lacquer from penetrating into the bodies and so that it is evaporated or evaporates after applying the electrically conducting lacquer. Such a liquid can include a liquid, for example water, that is completely non-miscible with the electrically conducting lacquer.

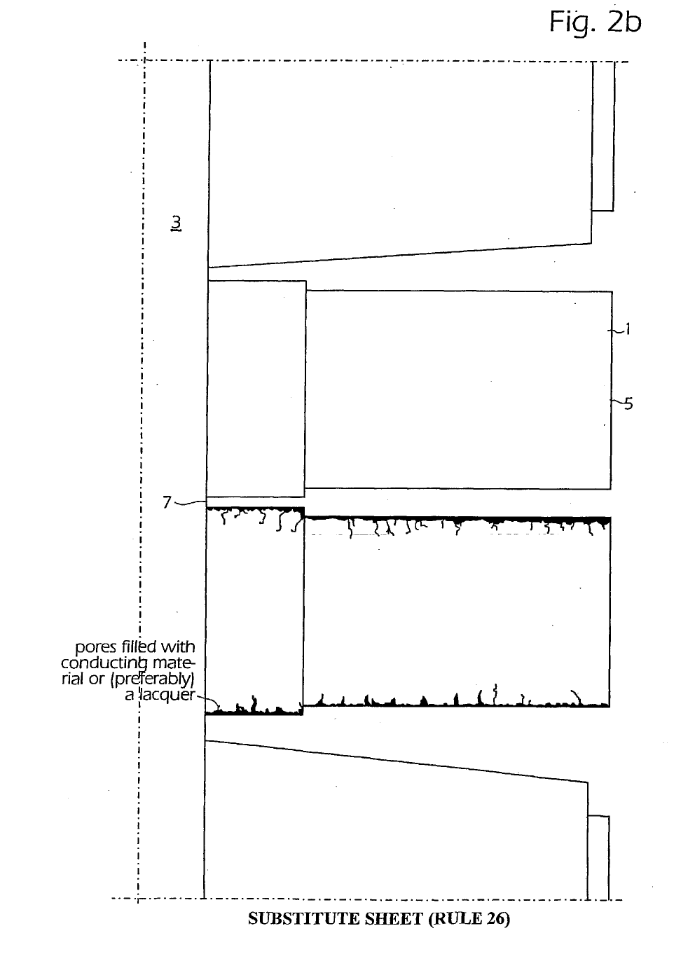

To mass manufacture waveguiding structures for for example antenna function often several moulds are required, for example one mould for one side and another one for the opposite side. In FIG. 3 a waveguide antenna is shown in which half of an antenna side is removed. Using this manufacturing method it is possible to make channels having adjacent sides in common and a more narrow interior portion. In such a case, as has been described above with reference to FIGS. 1 and 2, the sides of the rods 1, which then correspond to portions of waveguide channels, and the common surfaces 7 between two rods are coated with conducting material but not the surface 5, at which two halves are to be joined to each other. Thereafter opposite surface of the antenna sides are joined to each other and continuous channels having optimized entrance and exit sides are obtained.

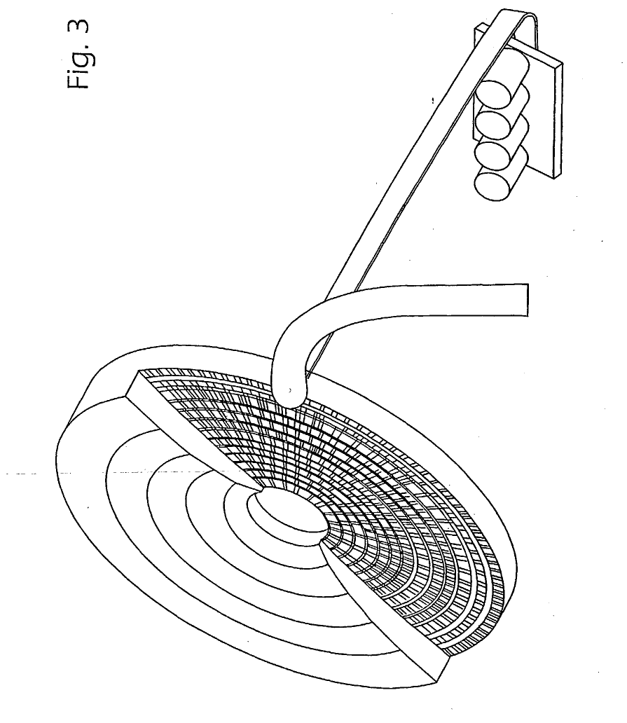

Devices having different kinds of waveguiding channels can be manufactured. In FIG. 4 for example waveguides are shown that are obtained from rods located at the sides of each other and having T-shaped cross-sections. The rods 1 generally have different shapes depending on the intended application. Thus they can have substantially square cross-sections, such as for waveguide channels for general use, or rectangular cross-sections, such as for waveguide lenses, filters and plan/circular-rotating arrays intended for only one of the polarisations of an electromagnetic wave.

Reflecting waveguides, not shown, can be manufactured by first producing suitable rod-shaped bodies according to the description above and that then one of the end surfaces of the bodies are coated with electrically conducting material in addition to the side surfaces. This gives a reflection, so that an incoming electromagnetic wave first enters the channels formed by the bodies from the uncoated ends of the rods and then turns and exits the same channels.

If suitable rod-shaped bodies are first produced according to the description above and then only two opposite side surfaces of the bodies are coated with electrically conducting surface layers, lenses or filters formed from parallel plates can be obtained which are intended for electromagnetic waves having a single polarisation.

The rods should generally have cross-sectional dimensions larger than half the largest wavelength for which their waveguiding functions are to be utilized for amplifying or filtering.

Simple waveguide channels, not shown, can be manufactured in the similar way. A simple straight body having for example a uniform rectangular cross-section is first produced. The body is bent to the desired shape and is then coated with one or several layers of electrically non-conducting lacquers, for example of an epoxy polymer, and finally with a layer of electrically conducting material. The coating with lacquers and in particular with a polymer material results in that the body will permanently maintain its shape.

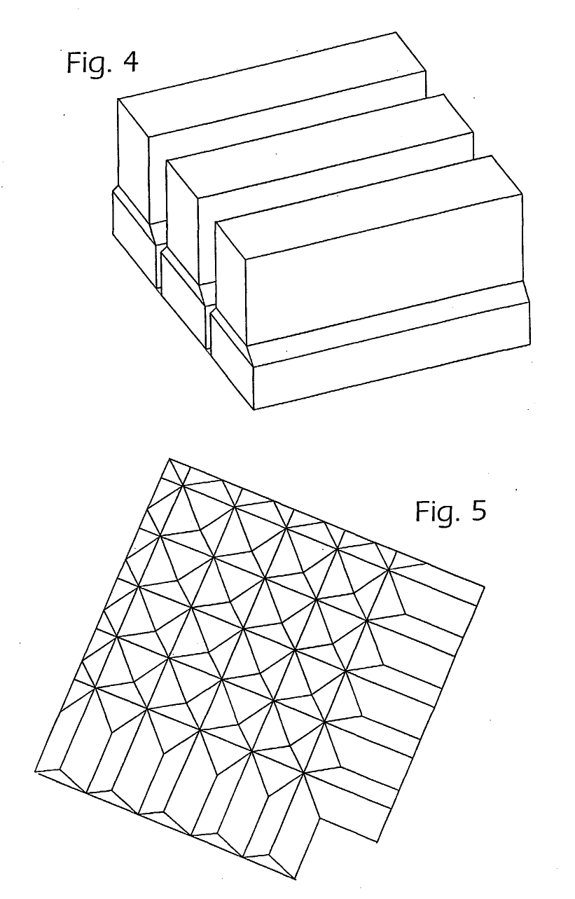

The property of attenuating electromagnetic waves of bodies of the mentioned materials directly coated with an electrically conducting lacquer can be used for manufacturing attenuating surface panels. An example of such a panel is shown in FIG. 5 and includes a plurality of conically shaped or pyramidal recesses located at the sides of each other and formed in one of the large surfaces of an otherwise flat body. The recesses are thus directly coated with electrically conducting paint. The panel works, for a suitable shape of the recesses and provided that the lacquer has well penetrated into the surface pores of the panel, attenuating to electromagnetic waves which are incident to the opposite large surface of the panel that can be substantially flat and is not coated with an electrically conducting layer. If a closed space is lagged with such panels, the flat surfaces of the panels directed to the interior of the space, a space is obtained in which possible electromagnetic waves are efficiently attenuated. The portions of the recesses located between the panels that correspond to the waveguide channels according to the description above should generally somewhere, for example at their entrances or at their central portions, have cross-sectional dimensions larger than half the largest wavelength for which their attenuating function is to be used.

1. A method of manufacturing a waveguide channel for electromagnetic waves, in particular microwaves, characterized in that a body is produced from a material substantially permeable for the electromagnetic waves and/or not significantly attenuating the electromagnetic waves and having a shape corresponding to the shape of the waveguiding channels and that exterior surfaces of the body is coated with electrically conducting material.

2. A method according to claim 1, characterized in that the body is first coated with at least one layer of electrically non-conducting lacquer or paint that is substantially permeable to and/or is not significantly attenuating to the electromagnetic waves and that fills pores and smooths the surfaces of the bodies, and that thereafter the coating with electrically conducting material is made.

3. A method according to claim 1, characterized in that to the body is first applied a layer of an electrically non-conducting liquid that fills pores and smooths the surfaces of the body, and that thereafter the coating with electrically conducting material is made, the liquid being selected to prevent the electrically conducting material from penetrating into the body and to be evaporated after coating with the electrically conducting material.

4. A method according to claim 1, characterized in that a plurality of bodies are produced as a multitude of rod-shaped bodies located at each other.

5. A method according to claim 1, characterized in that a plurality of bodies are produced as a plurality of rod-shaped bodies located at each other which project from a base plate.

6. A method according to claim 1, characterized in that the body is produced from an expanded polymer material, in particular expanded polystyrene.

7. A method according to claim 1, characterized in that the body is produced from a polymer material having a surface porosity.

8. A method according to claim 1, characterized in that the layer of electrically non-conducting lacquer is applied to the bodies by dipping or an inmould-method.

9. A method according to claim 1, characterized in that waveguiding channels are separately produced and are thereafter joined to each other.

10. A method according to claim 1, characterized in that at least two separate bodies are produced and coated with electrically conducting material and that the bodies are thereafter joined to each other.

11. A method according to claim 1, characterized in that side surfaces and only one end surface of the body are coated with the electrically conducting material to give a reflection, so that incoming electromagnetic waves first pass into the channel formed by the body through the uncoated end surface and then turn and pass out of the same channel.

12. A method according to claim 1, characterized in that only two opposite side surfaces of the body are coated with the electrically conducting material for obtaining lenses or filters intended for only a single polarisation of the electromagnetic waves.

13. A waveguide channel for electromagnetic waves, in particular microwaves, characterized by a body of a material substantially permeable for the electromagnetic waves and/or not significantly attenuating the electromagnetic waves having a shape corresponding to the shape of the waveguiding channels, exterior surfaces of body coated with a layer of electrically conducting material.

14. A method of manufacturing a structure attenuating to electromagnetic waves, in particular microwaves, characterized in that a plate-shaped body is produced from a material substantially permeable for the electromagnetic waves and/or insignificantly attenuating for the electromagnetic waves having a surface porosity including cut-outs or recesses made in a first large surface of the body and that the first large surface is coated with electrically conducting material for forming an electrically conducting surface layer having a rough lower surface at the continuation to the permeable and/or non-attenuating material, so that for waves incoming to the body, to a second, opposite large surface of the body, the rough lower surface works attenuating.

15. A method according to claim 14, characterized in that in producing the plate-shaped body the cut-outs or recesses are given such a shape that therebetween projecting rods are formed the dimensions of the cross-sections of which somewhere is larger than half the wavelength of the electromagnetic waves in the material having a surface porosity so that in addition to the attenuating effect produced by the rough lower surface the waves are also prevented because of the cross-sectional dimensions of the channels formed by the rods into which they penetrate.

16. A structure for attenuating electromagnetic waves, in particular microwaves, characterized by a plate-shaped body of a material substantially permeable for the electromagnetic waves and/or not significantly attenuating the electromagnetic waves and having a surface porosity, the body having cut-outs or recesses made in a first large surface of the body and the first large -surface being coated with an electrically conducting surface layer of electrically conducting material, that has a lower surface at the continuation to the permeable and/or non-attenuating material, which is rough because of the electrically conducting material penetrating into surface pores of the body, so that for waves incoming to a second, opposite large surface of the body, the rough lower surface works attenuating.
